(19) United States
(12) Patent Application Publication
(10) Pub. No.: US 2011/0279253 A1
(43) Pub. Date: Nov. 17, 2011

(54) APPARATUS AND METHOD FOR RFID-PLC CONTAINER IDENTIFICATION AND TRACKING

(76) Inventor: Raymond Anthony Suda, Sterling Heights, MI (US)

(21) Appl. No.: 13/014,751

(22) Filed: Jan. 27, 2011

Related U.S. Application Data
(60) Provisional application No. 61/334,633, filed on May 14, 2010.

(51) Int. Cl. G08B 21/00

(52) U.S. Cl. 340/431

(57) ABSTRACT

An RFID-PLC includes an RP tag mounted on a vehicle trailer, which is coupled to a power line communication system coupled between the trailer and a tractor. An RFID interrogator subsystem in the RP tag wirelessly obtains data from the RFID container tag and transmits the RFID date through the tractor-trailer PLC system. A PLC telemetric unit communicates with external satellite and computer based host systems through cellular, satellite, Wi-Fi 802 and BlueTooth Cellular communications.

### CROSS REFERENCE TO CO-PENDING APPLICATIONS

This application claims priority benefit to the filing date of co-pending U.S. Provisional Patent Application Ser. No. 61/334,633 filed on May 14, 2010 in the name of Raymond A. Suda, and entitled Multi-Voltage RFID-PLC Tag, the entire contents of which are incorporated herein by reference.

### BACKGROUND

Radio frequency identification devices or RFID tags are widely used to track a large number of diverse articles. Such tags have found widespread use in shipping containers to enable a transport system to track an individual container as it moves through the shipping industry and subsequent trucking industry to the customer.

RFID tags on storage containers in a port/truck facility are tracked and located by portable or stationary interrogator systems. However, since such containers are stacked many containers high in columns and the columns are arranged in close proximity to adjacent columns, interference can occur in the interrogator signals which make it difficult to locate one particular storage container.

At the same time, once a particular storage container with RFID tag is placed on a trailer which is coupled to a tractor, the ability to access the RFID data identifying the storage container by ID number, contents, customer information, etc., is lost. Although the tractor and trailer may have an onboard PLC data communication system for communicating tractor and trailer information between the tractor and trailer and/or to a remote computer based system, the information stored in the storage container RFID is not accessible.

Thus, would be desirable to provide a system which enables the data stored in RFID tags on storage containers mounted on a trailer coupled to a tractor to be accessible by the onboard tractor-trailer PLC communication system.

### SUMMARY

An apparatus for data communication between a tractor-trailer and a remote terminal includes a power line carrier system coupled to at least one power conductor coupled between a tractor and a trailer for communicating data signals over the at least one power conductor between the tractor and the trailer, a radio frequency identification tag carried on a portable storage container and containing storage container data, a radio frequency identification device interrogator carried on a trailer for wirelessly obtaining the storage container data from the tag on the storage container when the storage container is mounted on the trailer; and a power line carrier-radio identification communication device mounted on one of the tractor, and the trailer for receiving the storage container data from the interrogator over the at least one power line conductor.

An apparatus for data communication between a coupled tractor and trailer wherein a radio frequency identification containing storage container data tag is carried on a portable storage container. The apparatus includes a power line carrier system coupled to at least one power conductor coupled between a tractor and a trailer for communicating data signals over the at least one power conductor between the tractor and the trailer. A radio frequency device interrogator is carried on a trailer for wirelessly obtaining the storage container data from the radio frequency identification tag on the storage container when the storage container is mounted on the trailer. A power line carrier-radio communication device is mounted on one of the tractor and the trailer for receiving the storage container data from the interrogator over the at least one power line conductor.

A method is disclosed for wirelessly communicating storage container data stored in a memory of a radio frequency identification device tag mounted on a portable storage container mounted on a trailer coupled to a tractor, the tractor and the trailer having a data communication pathway including at least one power conductor coupled between the trailer and the tractor the method includes the steps of:

providing a radio frequency identification device interrogator on the trailer for wirelessly obtaining the storage container data from the tag on the storage container when the storage container is mounted on the trailer; and

providing a power line carrier-radio identification communication device mounted on one of the tractor and the trailer for receiving the storage container data from the interrogator over the at least one power line conductor.

### BRIEF DESCRIPTION OF THE DRAWING

The various features, advantages and other uses of the present will become more apparent by referring to the following detailed description and drawing in which:

FIG. 1 is a pictorial representation of a container chassis monitoring system;

FIG. 2 is a schematic diagram of the RP tag and PLC tractor/trailer communication system shown in FIG. 1;

FIG. 3 is a block diagram of the RP tag system shown in FIG. 2;

FIG. 4 is a schematic diagram of an RP tag-BlueTooth System used in the container chassis monitoring system shown in FIG. 1; and

FIG. 5 is a block diagram of an alternate RP tag-BlueTooth System.

### DETAILED DESCRIPTION

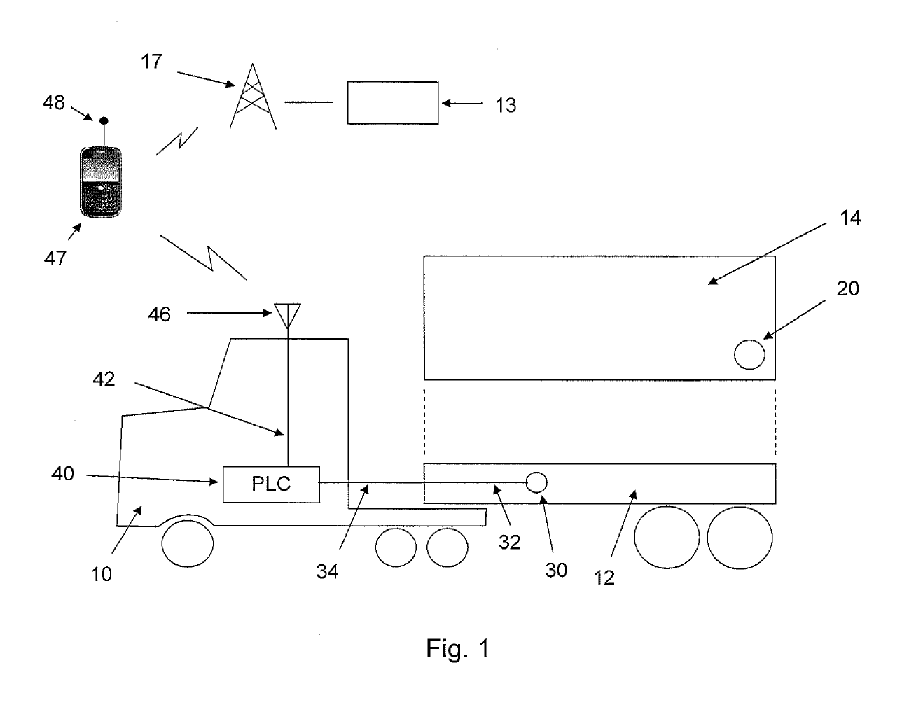

FIG. 1 depicts a container chassis monitoring system. In FIG. 1, a tractor vehicle 10 is depicted along with a chassis-type trailer 12. The chassis-type trailer 12 is configured for removably receiving a freight storage container 14.

An RFID tag 20 is mounted at a suitable location on the container 14. The RFID tag 20 contains a data memory that has been programmed with data identifying the container 14, and/or its contents, its destination, etc, according to ISO 18000-7 protocols. The RFID tag maybe any available tag, such as an asset tag sold by RFind Systems, Inc., Kelowno, British Columbia, Canada.

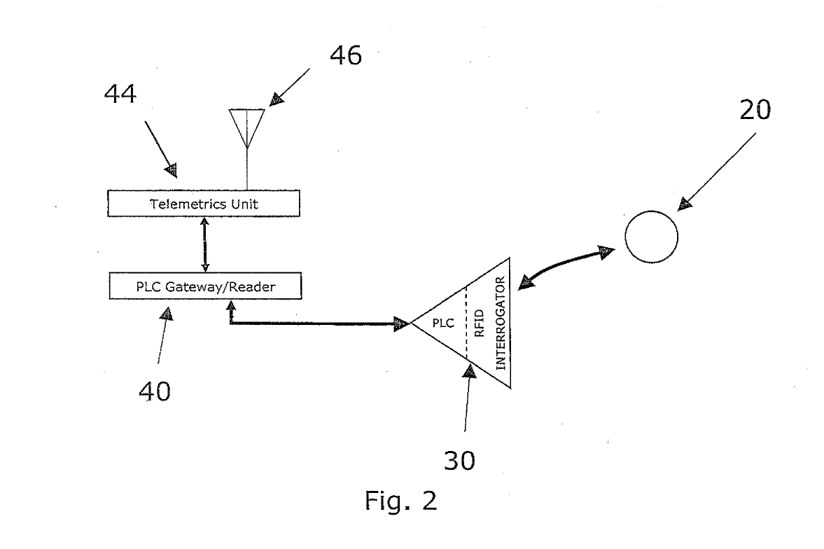

An RP tag 30 is coupled by electrical conductors or wiring 32 on the trailer 12 to power line connectors 34 used to couple and provide power and communications between the electrical systems of the tractor 10 and the trailer 12. The RP tag 30 functions to modulate the data from the RFID tag 20 onto a power line conductor 34 to a PLC reader or mounted in the tractor 10. The PLC gateway 40 typically communicates by hardwire conductors 42 to a telemetrics unit 44. As shown in FIG. 2, the telemetrics unit 44 communicates through an antenna 46 to a satellite, not shown, to communicate the data from the RFID tag 20 to an external host computer-based system. The telemetrics unit 44 maybe any OBC device using J1708, J1939, J1587, RS232, CanBus USB etc. The telemetric unit 44 can also communicate with the external satellite and computer based host system through cellular, satellite, Wi-Fi, 802 etc., communications.

The telemetrics unit 44 can also have tracking options such as GPS, RFID, RTLS, etc.

Telemetric units 44 are available from a number of companies, including, for example, Qualcomm, GE, International Telemetrics, RTL, Xata, Peoplenet, Skybitz, StarTrak, Partech, Cadec, FleetMind, Turnpike, Navman, ID Systems etc.

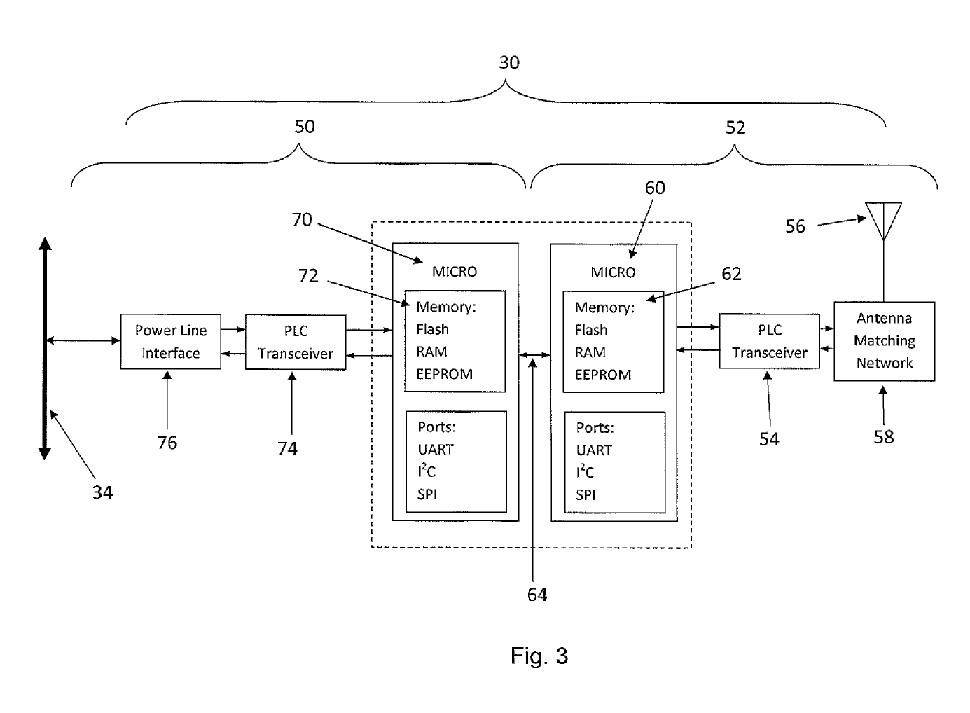

Referring now to FIGS. 2 and 3, the major components of the RP tag 30 are illustrated in block diagram form. The RP tag 30 is formed of two major subsystems, namely, a PLC subsystem 50 and an RFID interrogator system 52.

The RFID interrogator system 52 operates according to ISO 18000-7 protocols for radio frequency identification via active air interface communications at 433.92 MHZ. The interrogator subsystem 52 is a device which communicates with the RFID tag 20 within RF communication range. The interrogator subsystem 52 controls the protocol, reads information from the tag 20, directs the tag 20 to store data in some cases, and insures message delivery and validity.

As shown in FIG. 3, the RFID interrogator subsystem 52 includes a radio transceiver 54, which is coupled to an antenna 56 by an antenna-matching network 58 for wireless communication with the RFID tag 20. The RFID interrogator subsystem 52 includes a processor 60 which accesses one or more types of memory 62 carried in the RP tag 30. The processor 60 is coupled to input and output ports which may be one or more of UART, I² C, or SPI.

The RFID interrogator subsystem 52 communicates with the PLC subsystem 50 via communication path 64.

The PLC subsystem 50 may be a modified PLC system manufactured by Hegemon Electronics, Inc., Sterling Heights Michigan. The PLC subsystem 50 functions as a reader to read the data from the RFID tag 20 as obtained and stored in the memory 62 of the RFID interrogator subsystem 52 and transforms the data into a format capable of communication over the existing tractor-trailer power lines 34. Thus, the PLC subsystem 50 includes a -processor 70 which accesses data and a control program stored in one or more memories 72. The PLC subsystem 50 includes the same input and output ports as the RFID interrogator subsystem 52, namely, UART, I²C, or SPI.

The PLC processor 70 communicates through a PLC transceiver 74 and a power line interface 76 to bidirectionally receive and transmit data from the RFID interrogator sub system 52 over the existing tractor-trailer power lines 34 to the PLC reader or gateway 40 mounted in the tractor 10. The PLC gateway 40 can also be a PLC CAN gateway sold by Hegemon Electronics, Inc. The gateway 40 provides a gateway for CAN, RS232, J1708 or J1939 equipped devices to get access to the PLC messages that reside on the tractor and trailer power lines 34. The gateway 40 thus acts as an interface between the telemetrics unit 44 and the RP tag 30 to bidirectionally relay messages from the RP tag 30 to the telemetrics unit 44 and vice versa.

The RP tag 30 coupled with the PLC reader or gateway 40 uniquely enables RFID tags 20 mounted on freight storage containers 14 to be identified along with other data stored in the tag 20, such as the contents of the container 14, and then read and transmitted by the RP tag 30, to the PLC reader or gateway 40 and then to the telemetrics unit 44 for retransmission to a host system remote from the tractor 10. This provides 24/7 monitoring of the container 14 and its contents during transportation to and from the shipping facility and the delivery point.

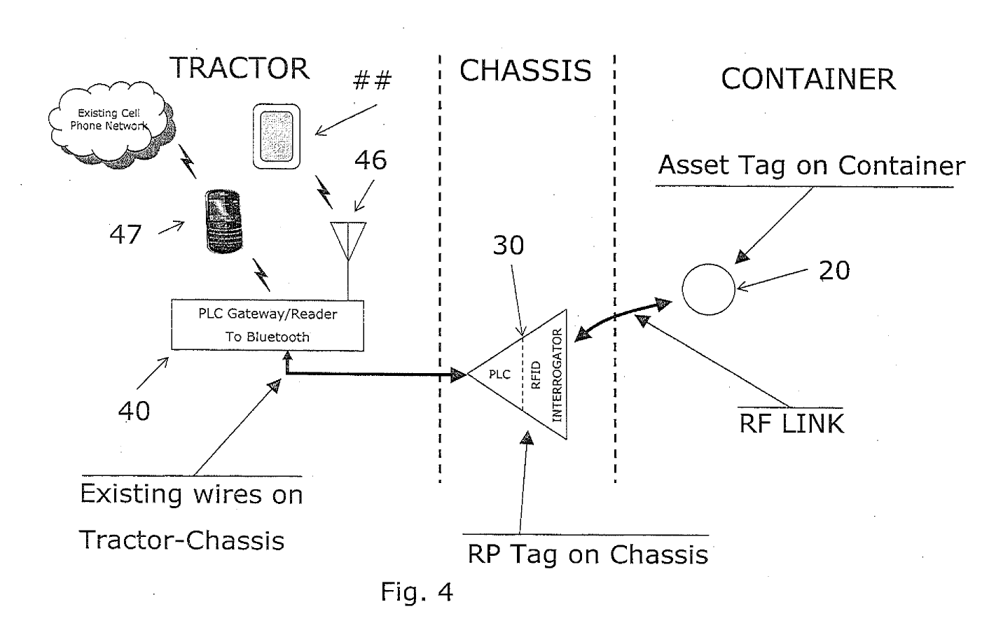

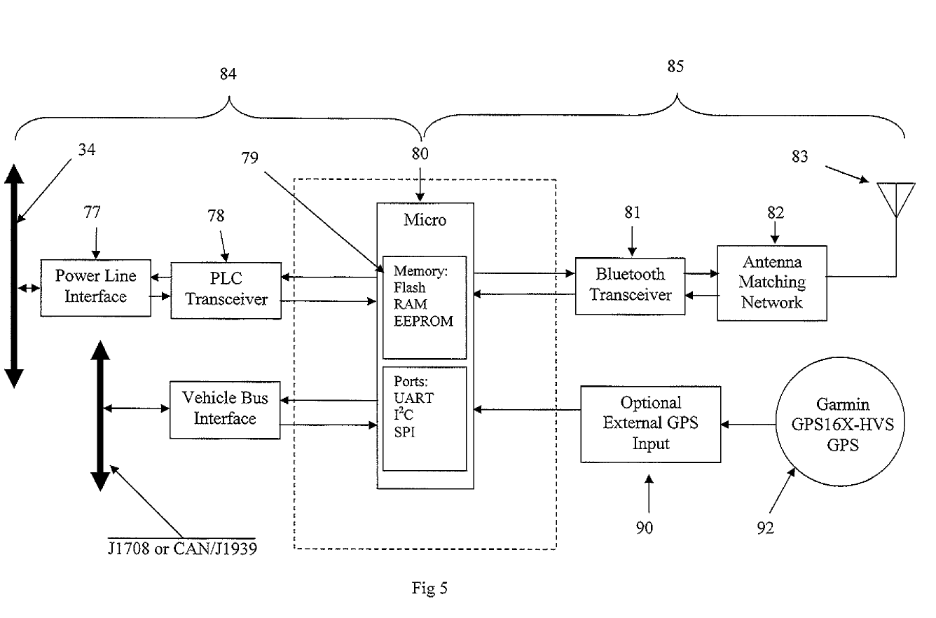

As shown in the alternate aspect depicted in FIGS. 4 and 5, the RP tag 30 functions to modulate the data from the RFID tag 20 onto the power lines 34 to a PLC reader or PLC gateway with a built in BlueTooth RF transceiver 40 mounted in the tractor 10. The unit communicates with a mobile communication terminal or cellular data transceiver, such as a cellular phone 47 or an iPad or iPad-like tablet computer device with Wi-Fi or 3G wireless communication capability, either automatically or by command of cellular phone 47 or unit 40 via radio frequency signals. As shown in FIG. 1, the cellular phone 47 communicates through an antenna 48 to a cellular network or satellite 11 to bi-directionally communicate the data from the RFID tag 20, through the PLC/Bluetooth unit 40 to the external host computer-based system 13. The PLC/BlueTooth unit may also contain interfaces such as J1708, J1939, J1587, RS232, RS485, CanBus, USB etc. for interface to the tractor's data bus. This will allow tractor vehicle information to also be sent to the cellular telephone 47. The cellular telephone unit 47 can also communicate with the external satellite and computer based host system 13 through cellular, satellite, Wi-Fi, 802 etc., communications.

The cellular telephone unit 47 can also have tracking options such as GPS, RFID, RTLS, etc. As optionally shown in FIG. 5, the Bluetooth gateway may have an optional external GPS input 90. An GPS unit 92, such as a Garmin Model No. GPS 16X-HVS, may be used to provide a GPS signal. The output of the external GPS unit 92 is connected to the Bluetooth gateway and sends GPS data to the Bluetooth gateway. This data would then be passed via a vehicle bus interface onto the Bluetooth host device via the Bluetooth connection. The Bluetooth host device, as described above, can be any suitably equipped cellular telephone, iPad or iPad like tablet computer device with Wi-Fi, 3G or 4G wireless communication capability. Such an input allows the tractor operator to obtain real time tracking information at less cost than a traditional truck mounted GPS tracking system. In addition, the tractor driver could use the tablet computer device to enter the information he needs to add data, such as quantity of fuel refills, driver logs, etc. This system could replace the traditional separate keyboard system used in a tractor for entering and seeing data in real time.

Cellular telephone units 47 are available from a number of companies, including, for example, Qualcomm, GE, AT&T, Sprint, Verizon, Motorola, Blackberry, Apple, etc.

The PLC processor 70 and the processor 60 can be merged into one processor.

Referring now to FIGS. 4 and 5, the major components of a PLC Gateway/Reader BlueTooth unit 40 are illustrated in block diagram form.

The PLC Gateway/Reader BlueTooth unit 40 is formed of two major subsystems, namely, a PLC subsystem 84 and an BlueTooth Radio Frequency transceiver system 85. The BlueTooth Radio Frequency transceiver system 85 operates according to industry standard BlueTooth protocols for cellular telephones via active air interface. The BlueTooth Radio Frequency transceiver system 85 is a device which communicates to the cellular telephone 47 or an iPad-like tablet communicating device within RF communication range. The BlueTooth Radio Frequency transceiver subsystem 85 controls the protocol, and sends information to the cellular telephone 47 and insures message delivery and validity.

As shown in FIG. 5, the BlueTooth Radio Frequency transceiver subsystem 85 includes a BlueTooth transceiver 81, which is coupled to an antenna 83 by an antenna matching network 82 for wireless communication with the cellular telephone 47. The BlueTooth Radio Frequency Subsystem 85 includes a processor 80 which accesses one or more types of memory 79 carried in the PLC BlueTooth subsystem or unit 85. The processor 80 is coupled to input and output ports which may be one or more of UART, I² C, SPI, or CAN.

The BlueTooth subsystem 85 communicates with the PLC subsystem 84 through the single shared microprocessor 80.

The PLC subsystem 84 may be a modified PLC system manufactured by Hegemon Electronics, Inc., Sterling Heights Mich. The PLC subsystem 84 functions as a reader to read PLC data from the existing vehicle power conductors 34 obtained and stored in the memory 79 of the processor 80 and transform the data into a format capable of communication over the wireless BlueTooth network. Thus, the PLC subsystem 84 includes a micro-processor 80 which accesses data and a control program stored in one or more memories 79. The PLC subsystem 84 includes the same input and output ports as the BlueTooth subsystem 85, namely, UART, I²C, SPI, or CAN. By use of a processor 80, the BlueTooth subsystem 85 and the PLC subsystem 84 can share data back and forth.

The-processor 80 communicates through a PLC transceiver 78 and a power line interface 77 to bidirectionally receive and transmit data to the BlueTooth subsystem 85 over the BlueTooth network to the Cellular telephone 47 that is either in or near the tractor 10. The PLC BlueTooth unit 40 can also be a PLC CAN gateway sold by Hegemon Electronics, Inc. The gateway 40 provides a gateway for CAN, RS232, J1708 or J1939 equipped devices to get access to the PLC messages that reside on the tractor and trailer power lines 34. The gateway 40 thus acts as an interface between the cellular telephone 47 and the RP tag 30 to bidirectionally rely messages from the RP tag 30 to the cellular telephone 47 and vice versa.

The RP tag 30 coupled with the PLC BlueTooth reader or gateway 40 uniquely enables RFID tags 20 mounted on freight storage containers 14 to be identified along with other data stored in the tag 20 pertaining to the contents of the container 14, and to be read and transmitted by the RP tag 30 and the PLC BlueTooth reader or gateway 40 to the cellular telephone 47 for retransmission to a host system 13 external to and remote from the tractor 10. This provides 24/7 monitoring of the freight storage container 14 and its contents during transportation to and from the ship facility and the delivery point.

What is claimed is:

1. An apparatus for data communication between a tractor and a trailer and a remote terminal comprising:
a power line carrier system coupled to at least one power conductor coupled between a tractor and a trailer for communicating data signals over at least one power conductor between the tractor and the trailer;
a radio frequency identification tag carried on a portable storage container and containing storage container data.
a radio frequency identification tag interrogator carried on the trailer for wirelessly obtaining the storage container data from the tag on the storage container when the storage container is mounted on the trailer and coupling the data to the at least one power conductor; and
a power line carrier-radio identification communication device mounted on one of the tractor and the trailer for receiving the storage container data from the interrogator over the at least one power line conductor.

2. The apparatus of claim 1 wherein the radio frequency identification device includes a memory for storing storage container data.

3. The apparatus of claim 2 further comprising:
the power line carrier subsystem including a processor capable of reading the data in a memory of the radio frequency identification tag interrogator.

4. The apparatus of claim 1 wherein the radio frequency identification device interrogator further comprises:
a radio frequency transceiver coupled to an antenna for wireless radio frequency communication with the radio frequency identification device tag on the portable storage container mounted on the trailer.

5. The apparatus of claim 4 further comprising:
a processor coupled to the radio frequency transceiver for accessing a memory in the radio frequency identification device tag on the storage container.

6. The apparatus of claim 5 further comprising:
the processor formatting the data read from the radio frequency identification device interrogator for communication over the at least one power line conductor via the power line carrier system.

7. The apparatus of claim 6 further comprising:
a transceiver for wirelessly communicating the storage container data from one of the tractor and trailer to a remote terminal.

8. The apparatus of claim 7 wherein:
the transceiver providing bi-directional data communication between a remote terminal and the power line carrier system.

9. The apparatus of claim 7 wherein:
the transceiver is a wireless mobile communication device.

10. The apparatus of claim 9 wherein the mobile communication device comprises:
one of a cellular telephone and a tablet computer device having wireless communication capability.

11. The apparatus of claim 10 further comprising:
a mobile communication terminal carried on one of the tractor and the trailer for wirelessly communicating data carried by the power line carrier system to the remote terminal.

12. An apparatus for data communication between a coupled tractor and trailer wherein a radio frequency identification tag containing storage container data is carried on a portable storage container comprising:
a power line carrier system coupled to at least one power conductor coupled between a tractor and a trailer for communicating data signals over the at least one power conductor between the tractor and the trailer;
a radio frequency identification tag carried on a portable storage container and containing storage container data;
a radio frequency identification tag interrogator carried on a trailer for wirelessly obtaining the storage container data from the radio frequency identification tag on the storage container when the storage container is mounted on the trailer and coupling the data to the at least one power conductor; and
a power line carrier-radio communication device mounted on one of the tractor and the trailer for receiving the storage container data from the interrogator over the at least one power line conductor.

13. The apparatus of claim 12 wherein the radio frequency identification device interrogator further comprises:
a radio frequency transceiver coupled to an antenna for wireless radio frequency communication with the radio frequency identification device tag on the portable storage container mounted on the trailer.

14. The apparatus of claim 13 further comprising:
a processor coupled to the radio frequency transceiver for accessing a memory in the radio frequency identification tag on the storage container.

15. The apparatus of claim 12 wherein the radio frequency identification tag includes a memory for storing storage container data.

16. The apparatus of claim 15 further comprising:
a power line carrier subsystem including a processor capable of reading the data in the memory of the radio frequency identification tag interrogator.

17. The apparatus of claim 16 further comprising:
the processor formatting the data read from the radio frequency identification device interrogator for communication over the at least one power line conductor via the power line carrier system.

18. The apparatus of claim 17 further comprising:
a transceiver for wirelessly communicating the storage container data from one of the tractor and trailer to a remote terminal.

19. The apparatus of claim 18 wherein:
the transceiver providing bi-directional data communication between a remote terminal and the power line carrier system.

20. The apparatus of claim 12 further comprising:
a mobile communication terminal carried on one of the tractor and the trailer for wirelessly communicating data carried by the power line carrier system to the remote terminal.

21. A method for wirelessly communicating storage container data stored in a memory of a radio frequency identification tag mounted on a portable storage container mounted on a trailer coupled to a tractor, the tractor and the trailer having a data communication pathway including at least one power conductor coupled between the trailer and the tractor, comprising the steps of:
providing a radio frequency identification device interrogator carried on the trailer for wirelessly obtaining the storage container data from the tag on the storage container when the storage container is mounted on the trailer;
the interrogator coupling the data to the at least one power conductor; and
providing a power line carrier-radio identification communication device mounted on one of the tractor and the trailer for receiving storage container data from the interrogator over the at least one power line conductor.

22. The method of claim 21 further comprising the step of:
providing a mobile communication terminal carried on one of the tractor and the trailer for wirelessly communicating data carried on at least one conductor to a remote terminal.

23. The method of claim 21 further comprising the steps of:
providing a memory in the radio frequency identification tag for storing storage container data.

24. The method of claim 21 further comprising the step of:
providing a radio frequency transceiver in the radio frequency identification device interrogator coupled to an antenna for wireless radio frequency communication with the radio frequency identification device tag on a portable storage container mounted on the trailer.

25. The method of claim 24 further comprising the steps of:
providing a processor coupled to the transceiver for accessing a memory in a radio frequency identification device tag on the storage container.

26. The method of claim 21 further comprising the step of:
providing a power line carrier subsystem including a processor capable of reading the data in a memory of the radio frequency identification tag interrogator.

27. The method of claim 26 further comprising the step of:
the processor formatting the data read from the radio frequency identification tag interrogator for communication over the at least one power line conductor via the power line carrier system.

28. The method of claim 27 further comprising the step of:
providing a transceiver in the interrogator for wirelessly communicating the storage container data from one of the tractor and trailer to a remote terminal.

29. The method of claim 28 further comprising the step of:
providing bi-directional data communication between a remote terminal and the power line carrier system.

30. The method claim 21 further comprising the step of:
a mobile communication terminal carried on one of the tractor and the trailer for wirelessly communicating data carried by the power line carrier system to the remote terminal.

31. The method of claim 30 further comprising the step of:
coupling GPS data from an external GPS device to the at least one power conductor for wirelessly communicating GPS data signals along with the storage container data from the tag to the power line carrier radio identification communication device.
